(19) United States
(12) Patent Application Publication
(10) Pub. No.: US 2026/0340303 A1
(43) Pub. Date: Oct. 29, 2026

(54) DYNAMIC SLOTS IN A CHAT SYSTEM

(71) Applicant: SAP SE, Walldorf (DE)

(72) Inventors: Praveen Kumar, Dhanbad (IN); Ruchi Kashyap, Bengaluru (IN); Krithika Vijayshankar, Bengaluru (IN)

(21) Appl. No.: 19/186,935

(22) Filed: Apr. 23, 2025

(51) Int. Cl. G06F 40/40; G06F 40/284; G06N 3/006

(52) U.S. Cl. CPC G06F 40/40; G06F 40/284; G06N 3/006

(57) ABSTRACT

Embodiments of the present disclosure include techniques for improving communications with a chatbot. In one embodiment, a software system receives a natural language user input from a chatbot and determines a user identification for the user. Configuration information for an organization associated with the user is retrieved from an external application. The configuration information specifies input field names and field types for a plurality of input variables to function calls on the external application. The input field names are sent to the chatbot for display to the user. Natural language responses to the input field names are received, where the natural language responses comprise unformatted values corresponding to the input field names. The responses are processed by an LLM, which produces formatted values and associated confidence scores corresponding to the input field names. The confidence scores are compared to a threshold value.

### BACKGROUND

The present disclosure relates generally to computer software systems, and in particular, to dynamic slots in a chat system.

Chatbots are software systems that allow users to interface with other software systems using natural language inputs. For a chatbot to function properly, certain natural language inputs (sometimes referred to as “slots”) of the chatbot are typically configured to work with particular inputs of the software system the chatbot is deployed to interface with. However, some software systems may vary their inputs based on a variety of factors. For example, some users associated with particular organizations may have different application inputs than other users associated with other organizations. Typically, coordinating chatbot inputs to align with application inputs is hard coded and fixed. Adjusting chatbot inputs to work with sometimes varying software application inputs may require time and labor intensive recoding of the system.

The following disclosure provides various technical solutions to overcome the above stated problems.

### BRIEF DESCRIPTION OF THE DRAWINGS

FIG. 1 illustrates a chatbot system with dynamic slots according to an embodiment.

FIG. 2 illustrates a method for dynamic chatbot slots according to an embodiment.

FIG. 3 illustrates an example system flow for dynamic chatbot slots according to an embodiment.

FIG. 4 illustrates an example preprocessing algorithm according to another embodiment.

FIG. 5 illustrates hardware of a special purpose computing system configured according to the above disclosure.

### DETAILED DESCRIPTION

Described herein are techniques for dynamic slots in a chatbot system. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

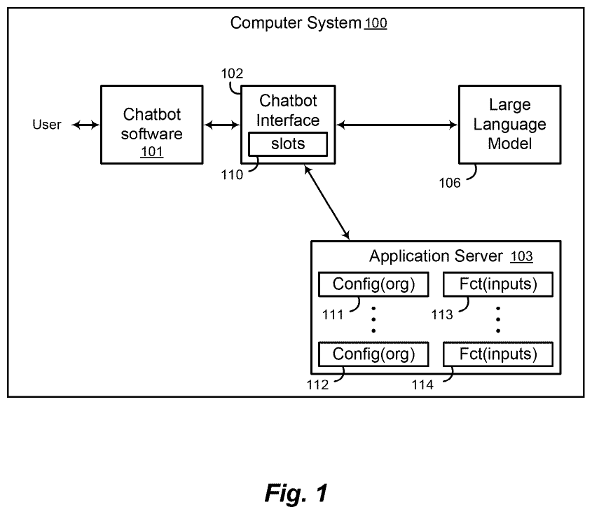

FIG. 1 illustrates a system for dynamic chatbot slots according to an embodiment. Features and advantages of the present disclosure include chatbot software 101 (herein, “chatbot”) interfacing with an application server 103 (herein, “application”) using chatbot interface 102 and a large language model (LLM) 106 executing on a computer system 100. Computer system 100 may include, for example, one or more computers comprising one or more processors and a computer readable medium (memory) for executing software to perform the techniques described herein. Here, embodiments of the present disclosure include techniques for dynamically assigning inputs (or slots 110) between chatbot 101 and application 103, which may be used to communicate input values from the chatbot to the application, for example.

A user may enter a natural language (NL) input to chatbot software 101. Chatbot software 101 sends the NL input to chatbot interface 102. In conventional solutions, chatbot software 101 is configured to parse the NL input for inputs that are compatible with an external application server 103 (aka, “application”) so that a user can invoke functionality of the application and use natural language to interact with the application. However, as previously mentioned, mapping portions of NL inputs on the chatbot to inputs of functions on application 103, referred to as “slots” (e.g., slots 110), required matching rigid configurations on the chatbot and application. Features and advantages of the present disclosure include determining inputs to functions on an application server 103 dynamically so the application has more flexibility in providing functionality through a chatbot.

The NL input from the user is received in chatbot interface 102 from chatbot software 101. First, chatbot interface 102 may determine a user identification (ID) for the user based on the input. Once the user ID is established, chatbot interface 102 may retrieve configuration information from application 103. The retrieved configuration information may define properties of the input to functions on application 103 to dynamically configure slots 110. For instance, chatbot interface 102 may send the user ID to application 103, and application 103 may use the user ID to determine configuration information for the user. In some embodiments, the user may be associated with a particular organization, and different organizations may have different configuration information. Configuration information may specify input field names and field types for a plurality of input variables (slots) to function calls on application 103, for example. The configuration information for the user's organization is sent from the application 103 to the chatbot interface 102. Configuration information for an organization, such as configuration information 111-112 (“Config(org)”) may be input field names and field types for invoking function calls 113-114 (“Fct(inputs)”) on application 103. An example of configuration information for an organization may be a list of APIs to invoke functions of an application, for example.

Next, the input field names from the configuration information may be sent by chatbot interface 102 to chatbot 101 for display (prompting) to the user. In some embodiments described below, the prompt of each input field name and the following steps may be done successively one input at a time, for example. Chatbot interface 102 may receive natural language responses to the input field names. The natural language responses comprise unformatted values corresponding to the input field names (e.g., in response to the prompt, “please enter the amount you spent on meals,” the user may enter, “the marketing team spent 2500 dollars on restaurants.”). It should be noted that while a user may have entered “2500 dollars,” the input to an application expense report function may require a decimal value with a designation of “USD” (e.g., “2500.00USD”) as an acceptable input for a particular function. In this case, “2500” is an unformatted value for the input field taken from the natural language response.

The natural language responses may be sent to a large language model (LLM) 106. In some embodiments described further below, the natural language responses may be preprocessed. In response, LLM 106 may generate one or more formatted values and associated confidence scores corresponding to the input field names. Using the example above, a formatted value from LLM 106 may be “2500.00USD” with an associated confidence score of 0.95. Chatbot interface 102 may compare the confidence scores to threshold values. When a confidence score meets a threshold value, the formatted value and the field type are sent to the external application 103. However, when a confidence score does not meet a threshold value, a modified value and the field type are sent to the external application 103. For example, when a confidence score is below a threshold value, chatbot interface 102 may send a suggestion to the user (e.g., the suggestion may comprise one or more of the other formatted values received from the LLM with lower confidence scores). The user may select another LLM generated value or enter their own value, for example, and the modified value is received by the chatbot interface 102.

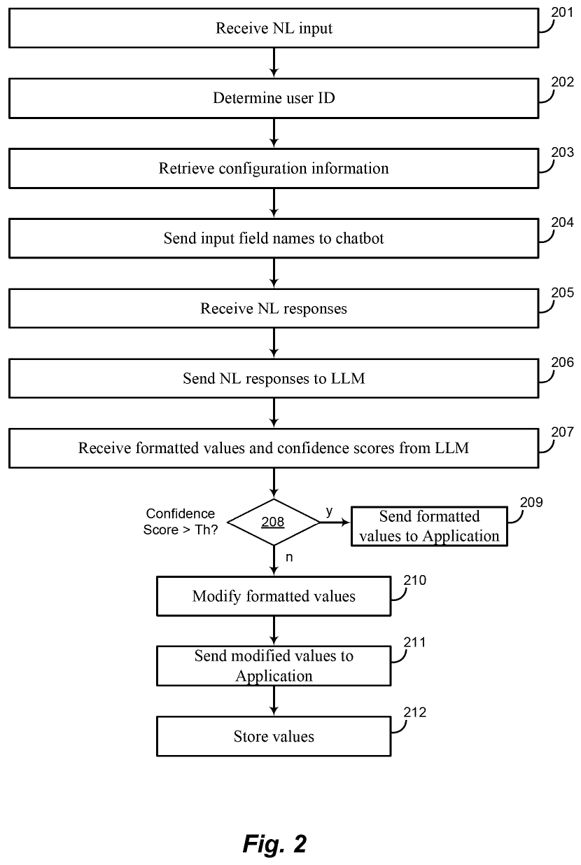

FIG. 2 illustrates a method for dynamic chatbot slots according to an embodiment. At 201, a chatbot interface receives, from a chatbot, a natural language (NL) input from a user. At 202, the chatbot interface determines a user ID for the user based on the input. At 203 the chatbot interface retrieves, from an external application and based on the user identification, configuration information for an organization associated with the user, the configuration information specifying input field names and field types for a plurality of input variables to function calls on the external application. At 204, the chatbot interface sends the input field names to the chatbot for display to the user. At 205, the chatbot interface receives, from the chatbot, natural language (NL) responses to the input field names, the natural language responses comprising unformatted values corresponding to the input field names. At 206, the chatbot interface sends the NL responses to a large language model. The NL responses may be preprocessed as described in more detail below. At 207, the chatbot interface may receive, from the large language model, formatted values and associated confidence scores corresponding to the input field names. At 208, the chatbot interface compares the confidence scores to a threshold value. The formatted values and the field types are sent to the external application when the confidence score meets the threshold value at 209. However, the formatted values from the LLM may be modified at 210 (e.g., a user selects a suggested value) and the modified values and the field types are sent to the external application when the confidence score does not meet the threshold value at 211. At 212, the system may store formatted values above the threshold or modified values for latter use. For example, the formatted values may be stored for a particular user when the confidence score meets the threshold value, and the modified values may be stored for the user when the confidence score does not meet the threshold value.

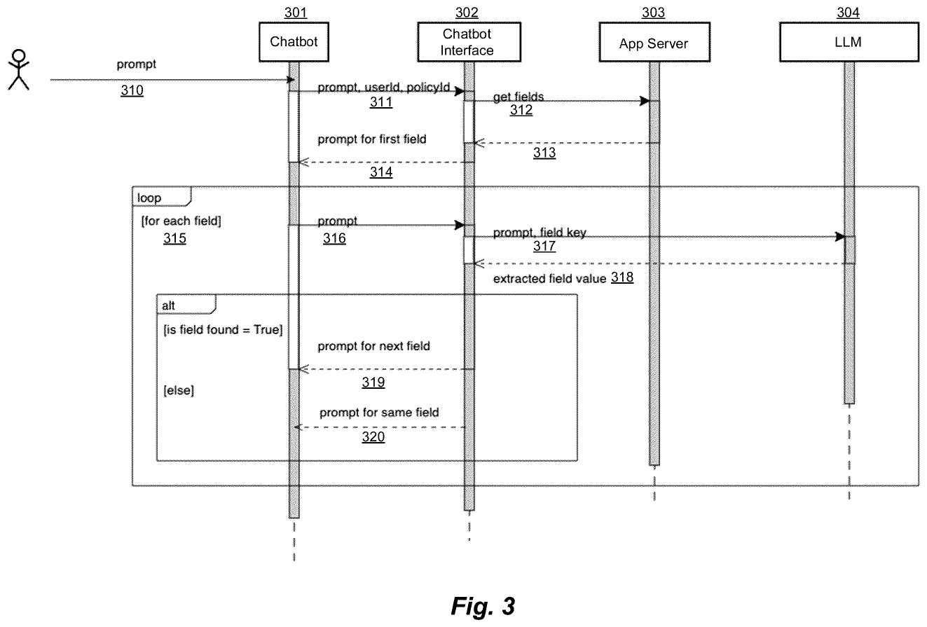

FIG. 3 illustrates an example system flow for dynamic chatbot slots according to an embodiment. Chatbot 301 receives a NL input 310 (aka, a prompt) from user. The prompt may be an expense report, for example. Chatbot 301 may determine the user ID and a policy ID based on the user and the document being processed (here, an expense report). At 311, the NL input, a user ID, and a policyID are sent to chatbot interface 302. A policyID is a code that defines a policy (e.g., a particular company's expense policy) that applies to a given document being processed (e.g., an expense report). PolicyIDs may be used to maintain companywide configurations applicable for all users, for example. At 312, chatbot interface 302 executes a “get_fields” call to an application server 303 (aka, backend). Application (App) server 303 uses the user ID to determine the user's organization and retrieves configuration information (input field names and types) for the organization. Configuration information is sent to the chatbot interface at 313. At 314, chatbot interface 302 sends the first field to chatbot 301, such as a first field of an expense report, for example.

The system flow then loops at 315 on each field as follows. At 316, an NL response (e.g., including an unformatted value of the next field) is sent to chatbot interface 302. In some embodiments, chatbot 301 sends the entire natural language response received from the user (e.g., the entire expense report) and one or more associated functions on the application, rather than mapping words of the expense report to slots using static local configuration information. At 317, the NL response and the input field name (e.g., from the configuration info) are sent to the LLM 304. Chatbot interface 302 may preprocess the NL responses before sending them to an LLM. The input field name is sometimes referred to as a field key because it may be used as a key in a query on app server 303, for example. At 318, extracted input field name formatted values and associated confidence scores are returned to chatbot interface 302. If the field is found (e.g., where a field is “found” when a confidence score is greater than a threshold value for a particular formatted value), then the next input field is processed by loop 315 at 319 and the next value obtained. However, if the field is not found, (e.g., where a field is “not found” when a confidence score is less than the threshold value), then the same field may be modified (e.g., displayed to the user with suggestions and the value modified), at 320.

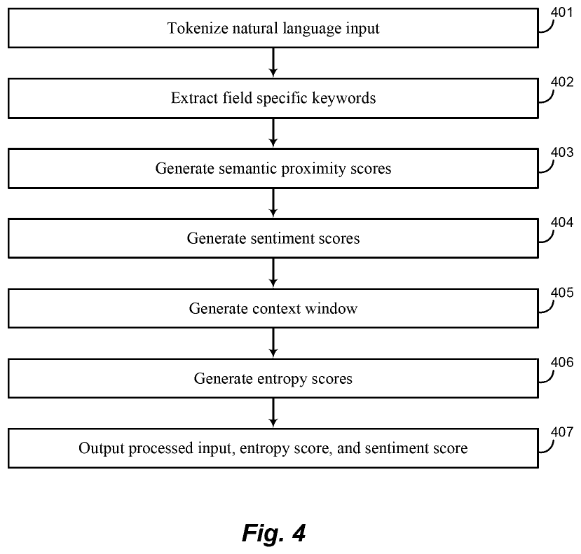

FIG. 4 illustrates an example preprocessing algorithm according to another embodiment. This example text preprocessing pipeline is used to transform raw text input into a structured format that's optimized to help an LLM extract specific fields in a more efficient manner. This example pipeline employs six distinct layers, each performing specialized processing operations. An example input is as follows:
“Yesterday I had an expensive business dinner with my colleagues Krithika and Ruchi from my team at Asha tiffins to discuss their upcoming software license renewal for $5,000”

Field Information pertains to the field to extract from the user prompt, which will come from the backend configuration. The following is an example:

field_info={‘label’: ‘transaction amount’, ‘dataType’: ‘STRING’}

A layer-by-layer analysis starts with Layer 1: Context-Aware Tokenization, which tokenizes the NL input. This initial layer is responsible for breaking down the input text into meaningful tokens while preserving important contextual elements. It handles special characters, numbers, and punctuation. The layer uses regular expressions to identify word boundaries and separates the text into individual tokens. The tokenization process converts all text to lowercase, removes punctuation while preserving numerical values, and separates words into individual tokens. In the current example, “$5,000” becomes “5000” while maintaining its semantic meaning (e.g., in this case amount was desired not the currency code).

Extracted output tokens are as follows:
[‘yesterday’, ‘i’, ‘had’, ‘an’, ‘expensive’, ‘business’, ‘dinner’, ‘with’, ‘my’, ‘colleagues’, ‘krithika’, ‘and’, ‘ruchi’, ‘from’, ‘my’, ‘team’, ‘at’, ‘asha’, ‘tiffins’, ‘to’, ‘discuss’, ‘their’, ‘upcoming’, ‘software’, ‘license’, ‘renewal’, ‘for’, ‘5000’]

Layer 2 involves field-specific keyword extraction as shown at 402. This layer focuses on identifying and extracting keywords that are specifically related to the target field. It creates a set of terms that will be used for further analysis. The keywords are extracted from the field label and datatype information. Extracted keywords for this example are: ‘transaction’ (from field label), ‘amount’(from field label), and ‘string’ (from dataType).

Layer 3 involves semantic proximity analysis. The third layer performs analysis of contextual relationships between tokens and field-specific keywords. Proximity scores are generated at 403 based on proximity and semantic connection. The analysis examines the surrounding context of each token and calculates a score based on its relationship to the target field keywords. Scores in our example are as follows:
‘5000’: 3.0 (Highest score-monetary amount)
‘expensive’: 2.5 (Cost-related descriptor)
‘for’: 2.0 (Preposition before amount)
‘business’: 1.5 (Context)
‘dinner’: 1.5 (Purchase item)

In this example, 5000 has the highest score as amount is desired.

Layer 4 involves sentiment-weighted processing. This layer incorporates sentiment analysis to provide additional context to the token relevance. A sentiment score may be generated at 404. For example, a sentiment polarity score is calculated for the entire text and adjusts the proximity scores accordingly. In our example:
Sentiment Polarity Score: 0.2 (slightly Positive)
Effect: Proximity scores were multiplied by 1.2 due to positive sentiment

The updated scores after sentiment weighting are as follows:
‘5000’: 3.6 (from 3.0)
‘expensive’: 3.0 (from 2.5)
‘for’: 2.4 (from 2.0)

Layer 5 involves dynamic context window generation shown at 405. This layer creates a focused context window containing the most relevant tokens based on their proximity scores and field keywords. It helps isolate the most important information by selecting the top-scoring tokens and combining them with field keywords. The generated context window for the current example is: “transaction amount 5000 expensive business dinner software.”

Layer 6 involves entropy-based information density analysis. The final layer evaluates the information density of the processed text using entropy calculations. Entropy scores are calculated at 406. This helps validate the quality and completeness of the extracted information. Information density metrics for the current example are as follows:
Total Unique Tokens: 28
Token Distribution: Mostly unique occurrences
Entropy Score: 4.75 (indicating high information density)

A final output of the preprocessing pipeline is shown at 407. The system may produce a structured output: {‘preprocessed_input’: ‘transaction amount 5000 expensive business dinner software’, ‘entropy_score’: 4.75, ‘sentiment_score’: 0.2}.

The above-described example pipeline achieves several key objectives and advantages. First, information preservation maintains exact monetary amounts, preserves cost context, and retains the transaction type and purpose. Second, context enhancement adds transaction-specific context, prioritizes amount-related terms, and maintains purchase type information. Third, the pipeline achieves noise reduction since the pipeline removes temporal markers, eliminates redundant prepositions, strips unnecessary pronouns, and focuses on amount-relevant context. Further, the pipeline achieves semantic optimization because the pipeline enhances amount context, maintains transaction-amount relationships, preserves monetary values, and retains cost descriptors.

The above example preprocessing pipeline has transformed raw text input into a structured format that emphasizes transaction amount information while preserving relevant context and removing noise, making it ideal for subsequent field extraction tasks. While the above example pipeline illustrates a number of steps that can be advantageously used in some embodiments, it is to be understood that other example preprocessing pipelines may omit certain steps and/or use only a portion of the above steps.

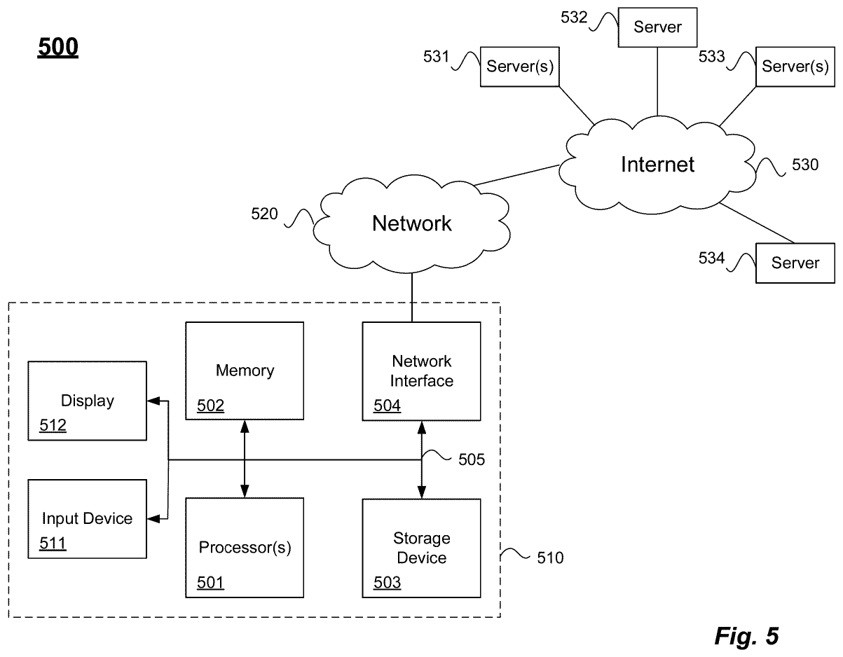

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: receiving, from a chatbot, a natural language input from a user; determining a user identification for the user based on the input; retrieving, from an external application and based on the user identification, configuration information for an organization associated with the user, the configuration information specifying input field names and field types for a plurality of input variables to function calls on the external application; sending the input field names to the chatbot for display to the user; receiving, from the chatbot, natural language responses to the input field names, the natural language responses comprising unformatted values corresponding to the input field names; sending the natural language responses to a large language model; receiving, from the large language model, formatted values and associated confidence scores corresponding to the input field names; and comparing the confidence scores to a threshold value, wherein the formatted values and the field types are sent to the external application when the confidence score meets the threshold value, and modified values and the field types are sent to the external application when the confidence score does not meet the threshold value.

In one embodiment, the method further comprises sending a suggestion to the user when the confidence score does not meet the threshold value and receiving the modified values from the user.

In one embodiment, the method further comprises storing the formatted values for the user when the confidence score meets the threshold value and storing the modified values for the user when the confidence score does not meet the threshold value.

In one embodiment, the chatbot sends the entire natural language response received from the user and an associated function on the external application.

In one embodiment, the input field names are sent to the user successively, and each natural language response is processed separately for each input field name.

In one embodiment, the method further comprises preprocessing natural language responses before sending the natural language responses to the large language model.

In one embodiment, preprocessing comprises: tokenizing the natural language responses to produce a plurality of tokens; extracting keywords from an input field associated with an input of the external application; generating proximity scores for each token based on the extracted keywords; selecting a subset of tokens having the highest proximity scores; and generating a context window comprising the subset of tokens.

In one embodiment, preprocessing further comprises: generating a sentiment weight; and modifying the proximity scores based on a sentiment weight.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
receiving, from a chatbot, a natural language input from a user;
determining a user identification for the user based on the input;
retrieving, from an external application and based on the user identification, configuration information for an organization associated with the user, the configuration information specifying input field names and field types for a plurality of input variables to function calls on the external application;
sending the input field names to the chatbot;
receiving, from the chatbot, natural language responses to the input field names, the natural language responses comprising unformatted values corresponding to the input field names;
sending the natural language responses to a large language model;
receiving, from the large language model, formatted values and associated confidence scores corresponding to the input field names; and
comparing the confidence scores to a threshold value, wherein the formatted values and the field types are sent to the external application when the confidence score meets the threshold value, and modified values and the field types are sent to the external application when the confidence score does not meet the threshold value.

2. The method of claim 1, further comprising sending a suggestion to the user when the confidence score does not meet the threshold value and receiving the modified values from the user.

3. The method of claim 1, further comprising storing the formatted values when the confidence score meets the threshold value and storing the modified values when the confidence score does not meet the threshold value.

4. The method of claim 1, wherein the chatbot sends the entire natural language response input from the user and one or more associated functions on the external application.

5. The method of claim 1, wherein the input field names are sent to the user successively, and each natural language response is processed separately for each input field name.

6. The method of claim 1, further comprising preprocessing natural language responses before sending the natural language responses to the large language model.

7. The method of claim 6, wherein preprocessing comprises:
tokenizing the natural language responses to produce a plurality of tokens;
extracting keywords from an input field associated with an input of the external application;
generating proximity scores for each token based on the extracted keywords;
selecting a subset of tokens having the highest proximity scores; and
generating a context window comprising the subset of tokens.

2. The method of claim 7, further comprising:
generating a sentiment weight; and
modifying the proximity scores based on a sentiment weight.

3. A computer system comprising:
at least one processor;
at least one non-transitory computer-readable medium storing computer-executable instructions that, when executed by the at least one processor, cause the computer system to execute a method comprising:
receiving, from a chatbot, a natural language input from a user;
determining a user identification for the user based on the input;
retrieving, from an external application and based on the user identification, configuration information for an organization associated with the user, the configuration information specifying input field names and field types for a plurality of input variables to function calls on the external application;
sending the input field names to the chatbot;
receiving, from the chatbot, natural language responses to the input field names, the natural language responses comprising unformatted values corresponding to the input field names;
sending the natural language responses to a large language model;
receiving, from the large language model, formatted values and associated confidence scores corresponding to the input field names; and
comparing the confidence scores to a threshold value, wherein the formatted values and the field types are sent to the external application when the confidence score meets the threshold value, and modified values and the field types are sent to the external application when the confidence score does not meet the threshold value.

10. The computer system of claim 9, further comprising sending a suggestion to the user when the confidence score does not meet the threshold value and receiving the modified values from the user.

11. The computer system of claim 9, further comprising storing the formatted values for the user when the confidence score meets the threshold value and storing the modified values for the user when the confidence score does not meet the threshold value.

12. The computer system of claim 9, wherein the chatbot sends the entire natural language input from the user and an associated function on the external application.

13. The computer system of claim 9, wherein the input field names are sent to the user successively, and each natural language response is processed separately for each input field name.

14. The computer system of claim 9, further comprising preprocessing natural language responses before sending the natural language responses to the large language model.

4. A non-transitory computer-readable medium storing computer-executable instructions that, when executed by at least one processor of a computer system, cause the computer system to execute method comprising:
receiving, from a chatbot, a natural language input from a user;
determining a user identification for the user based on the input;
retrieving, from an external application and based on the user identification, configuration information for an organization associated with the user, the configuration information specifying input field names and field types for a plurality of input variables to function calls on the external application;
sending the input field names to the chatbot;
receiving, from the chatbot, natural language responses to the input field names, the natural language responses comprising unformatted values corresponding to the input field names;
sending the natural language responses to a large language model;
receiving, from the large language model, formatted values and associated confidence scores corresponding to the input field names; and
comparing the confidence scores to a threshold value, wherein the formatted values and the field types are sent to the external application when the confidence score meets the threshold value, and modified values and the field types are sent to the external application when the confidence score does not meet the threshold value.

16. The non-transitory computer-readable medium of claim 15, further comprising sending a suggestion to the user when the confidence score does not meet the threshold value and receiving the modified values from the user.

17. The non-transitory computer-readable medium of claim 15, further comprising storing the formatted values for the user when the confidence score meets the threshold value and storing the modified values for the user when the confidence score does not meet the threshold value.

18. The non-transitory computer-readable medium of claim 15, wherein the chatbot sends the entire natural language input from the user and an associated function on the external application.

19. The non-transitory computer-readable medium of claim 15, wherein the input field names are sent to the user successively, and each natural language response is processed separately for each input field name.

20. The non-transitory computer-readable medium of claim 15, further comprising preprocessing natural language responses before sending the natural language responses to the large language model.
